(19) United States
(12) Patent Application Publication
(10) Pub. No.: US 2023/0163474 A1
(43) Pub. Date: May 25, 2023

(54) SCATTERING DEVICE

(71) Applicant: UNIVERSITY OF EXETER, Exeter (GB)

(72) Inventors: Alex POWELL, Exeter (GB); Roy SAMBLES, Exeter (GB); Joseph BEEDEL, Exeter (GB); John WARE, Exeter (GB)

(21) Appl. No.: 17/997,734

(22) PCT Filed: Apr. 30, 2021
(86) PCT No.: PCT/GB2021/051053

§ 371 Date: Nov. 1, 2022

(30) Foreign Application Priority Data
May 1, 2020 (GB) 2006470.5

(51) Int. Cl. H01Q 9/28; H01Q 15/00

(52) U.S. Cl. CPC H01Q 9/285; H01Q 15/0046; B33Y 80/00

(57) ABSTRACT

A scattering device 10 is described comprising a plurality of dipoles 20, each comprising a rod and a pair of plates 12, 22, the plates 12, 22 being located at the respective ends of the rod, the rods of the dipoles 20 being connected to one another and arranged such that the rods are angled relative to one another.

This invention relates to a device of enhanced scattering ability, for example designed in such a manner as to permit extremely powerful backscattering of microwave radiation irrespective of the direction of the incident radiation.

The world around us from the seas to outer space is becoming crowded with objects that are difficult to detect via conventional radar, from established technologies such as small boats and gliders, to newer devices like quadcopter drones and fist-sized cubesats in outer space. The issue of detectability of these new technologies is causing significant problems. By way of example, inability to reliably detect the presence of drones and the like has led to the shutting down of airports and the loss of dozens of satellites, which remain in orbit as dangerous space-junk.

Traditional methods to boost the radar scattering cross-section (RCS) of an object that does not interact strongly with electromagnetic radiation are the addition of a high RCS element such as a corner reflector or a partially coated Luneberg lens. The operation of these RCS-boosting systems is based around the reflection and/or diffraction of microwave radiation, and as such their size must be at least a few wavelengths across in order to ensure efficient operation, and so they are generally rather large (>20 cm) and heavy. This precludes their use in small or lightweight applications, such as gliders, and quadcopter drones, which have notoriously small RCS, and where a reliable way to boost the detectability remains a significant problem. It is desirable to provide an arrangement by the RCS of an object may be boosted with minimal impacts on the weight and size of the object.

An alternative to the use of diffraction-limited systems is to utilise subwavelength resonant structures which interact very strongly with incoming radiation and scatter extremely efficiently about a defined resonance, which can be tuned via their geometry. This idea has long been utilised in optics for applications from sensing to light management in solar cells, but has not been exploited in the microwave regime.

It is an object of the invention to provide a scatterer or scattering device whereby at least of the disadvantages or issues set out hereinbefore can be overcome or their effects mitigated against.

According to a first aspect of the present invention there is provided a scattering device comprising a plurality of dipole structures, each comprising a rod and a pair of plates, the plates being located at the respective ends of the rod, the rods of the dipole structures being connected to one another and arranged such that the rods are angled relative to one another.

Whilst the rods may be straight, this need not always be the case and they could be, for example, of curved, twisted or helical form. The shape and size of the rods may be selected to in order increase the path length and tune the frequency response of the device.

The plates, in one embodiment of the invention, may be of generally square shape. Conveniently, three dipoles are provided. The dipoles are preferably arranged such that the plates together define a structure of generally cubic shape, with the interconnected dipoles together defining a support structure for the plates. However, the invention is not restricted in this regard and arrangements in which the plates are of other shapes, and/or in which the structure is of a different shape are possible without departing from the scope of the invention.

The plate thickness, along with the rod length as mentioned above, may be selected relative to the wavelength to which the device is required to be sensitive, to achieve tuning, for example to a radar or the like with which the device is to be used.

Where the structure is of generally cubic form, each plate being of generally square shape, referred to herein as a 3D metacube, it has been found that the structure can serve as a powerful subwavelength scatterer, with an RCS profile many times, for example around fifteen times, its geometric cross section. The 3D metacube is effectively constructed of three orthogonal capacitively loaded dipole antennas, and as such shows omnidirectional scattering behaviour, with an RCS that is unchanged at the fundamental resonance by incident angle and polarisation. Higher order resonances are affected by angle or polarisation, for example by up to around 6% the amount of variation in the intensity depending on the geometry of the device, with spheres being more isotropic than cubes, and elongated spheres being less isotropic.

Each dipole may be of solid form, for example of solid copper form. Alternatively, the dipoles may be of non-metallic form, provided with a metallic material coating. Conveniently, the dipoles are manufactured integrally with one another.

Advanced manufacturing methods such as additive manufacturing via stereolithography and nanocrystalline electroforming may be used in the fabrication of these complex geometries to a high level of precision. Through simulation and experiment, the potential of this technique to create 3D omnidirectional superscatterers has been confirmed. Other manufacturing techniques include electroplating.

According to a second aspect of the present invention there is provided a system comprising a first scattering device according to the first aspect and a mirroring element, the mirroring element operable, in use, to form a charge pattern of a scattering device according to the first aspect, wherein the first scattering device and mirroring element are positioned relative to one another to interact electromagnetically in use.

The first scattering device and mirroring element may be positioned relative to one another to, in use, form a hybrid mode.

The mirroring element may be a second scattering device according to the first aspect. Alternatively, the mirroring element may be a perfect electrical conductor. In particular, the mirroring element may be a body of metal.

One or more of the scattering devices of the second aspect of the present invention may have any or all of the optional features of the first aspect, as desired or appropriate. In particular, but not exclusively, one or more of the scattering devices may be a 3D metacube.

The first scattering element and the mirroring element may be positioned with a spacing between them of between 10-20 mm. The first scattering element and the mirroring element may be positioned with a 20 mm spacing between them. The first scattering element and the mirroring element may be positioned with a 10 mm spacing between them. Particularly when the mirroring element is a perfect electric conductor, the first scattering element may sit above the mirroring element. The first scattering element may sit on the mirroring element. The mirroring element may be operable to form the charge pattern of a scattering device according to the first aspect in response to exposure to a charge pattern of the first scattering element.

The first and second scattering elements may be positioned relative each other with one of the plates of the first scattering element facing one of the plates of the second scattering element.

The first scattering element and mirroring element may be positioned such that, in use, a first charge of the first scattering element faces a first charge of the mirroring element, the first charge of the first scattering element having an opposite sign to the first charge of the mirroring element. The first scattering element and mirroring element may be positioned such that, in use, second charges, each of the same dipole as the respective first charge, of the first scattering element and mirroring element have opposite signs to each other.

The invention will further be described, by way of example, with reference to the accompanying drawings, in which:

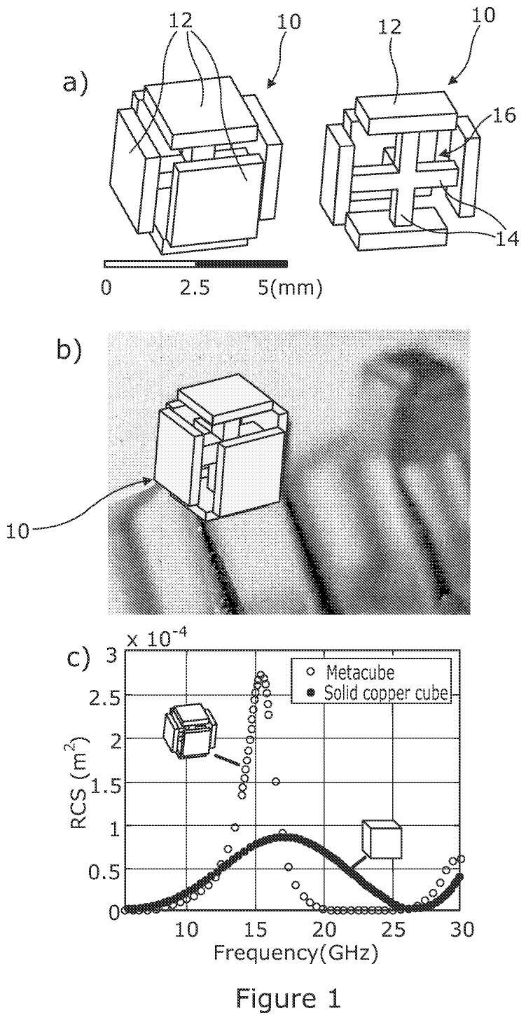

FIG. 1: a) 3D diagram of the metacube used for initial superscattering experiments; b) Metacube samples, 3D printed using a stereolithography printer and then metallised via electroplating; c) The modelled RCS of a 4.35 mm metacube and solid copper cube showing the increase in scattering power created by the structure of the cube;

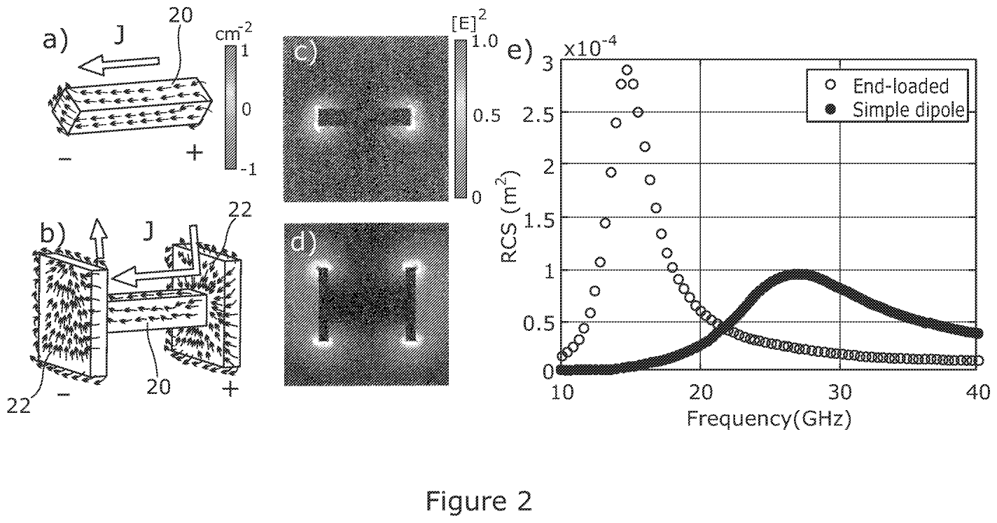

FIG. 2: The normalised surface charge (colouration) and surface current (arrows) for a simple square rod (a) and an identical rod terminated with square plates (b), which is equivalent to one third of the metacube; Normalised electric field profiles for each are shown in (c) & (d); The RCS for both structures is shown in (e);

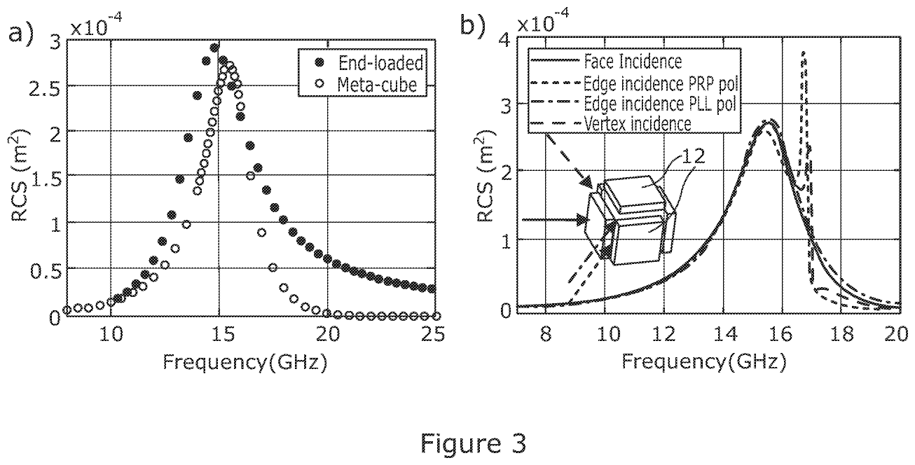

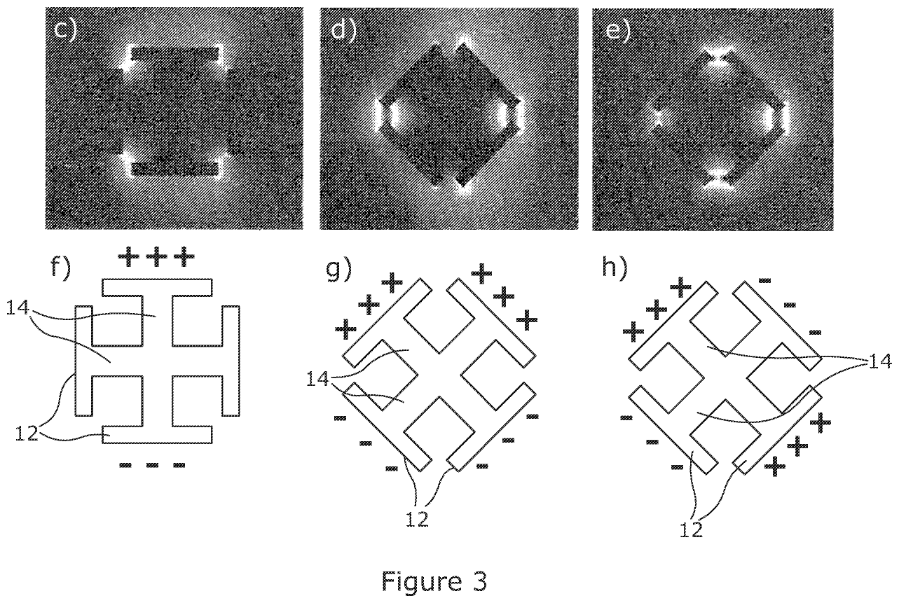

FIG. 3: a) RCS showing the difference between a single, end-loaded dipole and the 3D metacube; (b) RCS of the metacube due to light incident along the principle directions and polarizations (inset); (c)-(e) Electric field plots and (f)-(g) charge distribution diagrams of the primary and secondary modes of metacubes with light incident normal to a face and normal to an edge with perpendicular polarisation;

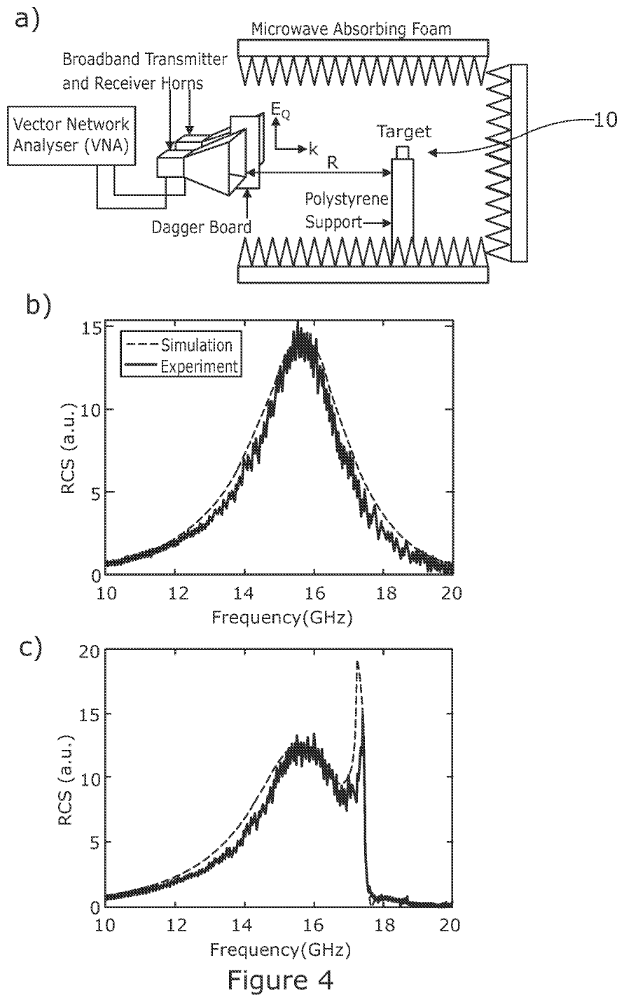

FIG. 4: (a) Experimental setup used to calculate the RCS; (b) & (c) Experimental and simulated results of the radar scattering cross section for the cubes at normal incidence to one of the faces and incidence angled at 45 degrees to that normal (edge incidence) polarized perpendicular to that edge;

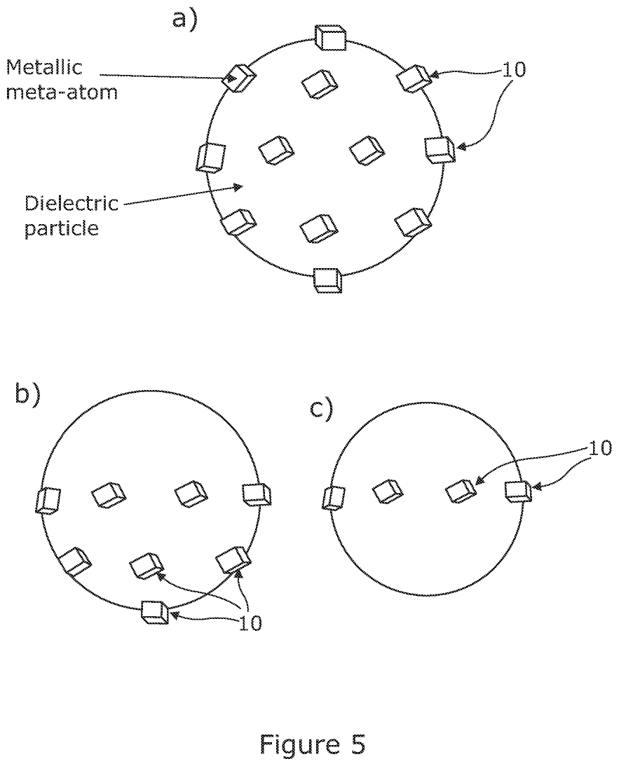

FIG. 5: A series of diagrammatic images of meta-particles;

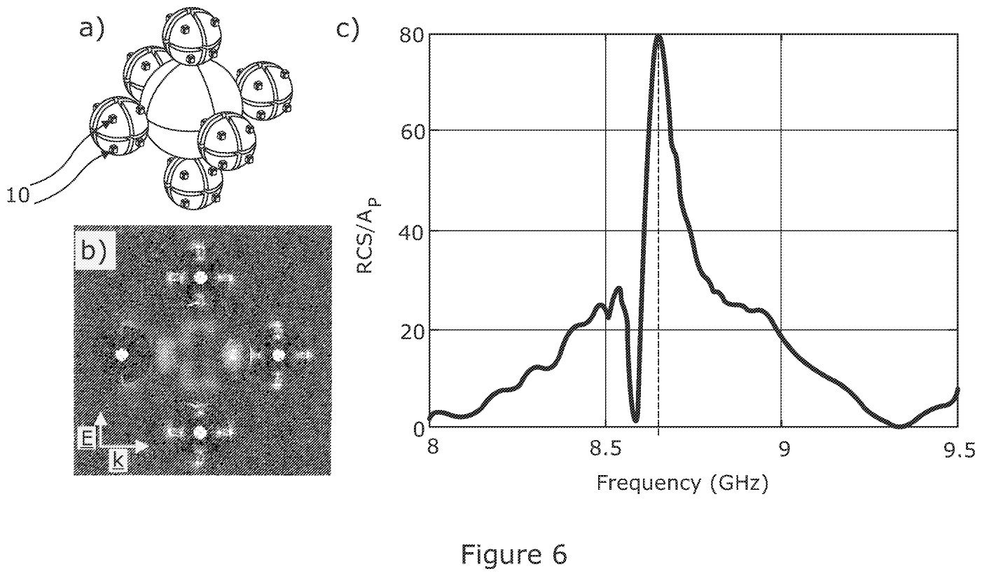

FIG. 6: Showing a meta molecule (a) made up of a central 25 mm dielectric particle of premix 1200, surrounded by six 14 mm diameter metallic meta-atoms. At 8.65 GHz (dotted red line) the modes in the meta-spheres and the dielectric core align (b) leading to a huge increase in the RCS (c);

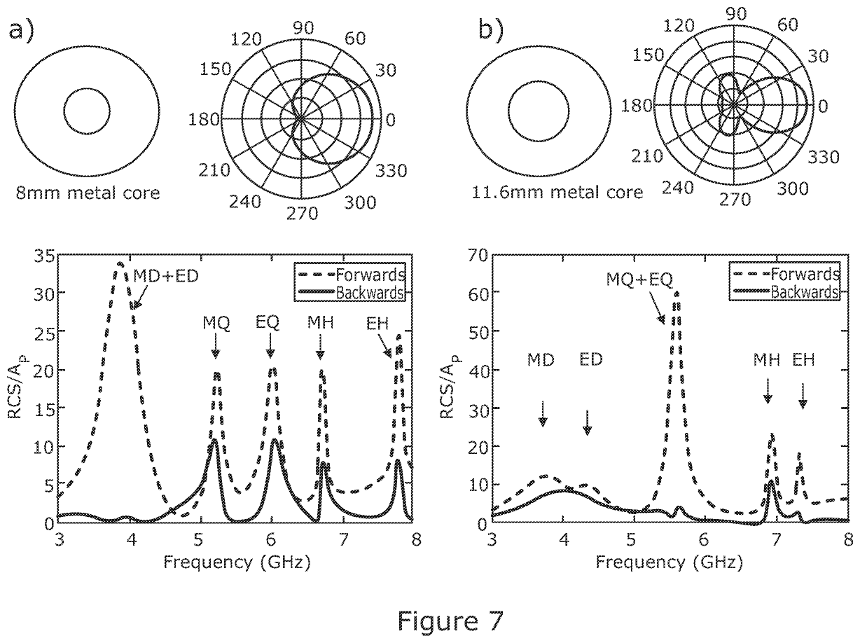

FIG. 7: The simulated monostatic RCS (normalized to the cross sectional area of the particle, Ap) and farfield scattering of a hollow 25 mm diameter sphere printed with premix 1200 containing a metallic meta-atom core with a diameter of (a) 8 mm and (b) 11.6 mm. The spectral positions of the magnetic and electric modes are shown up to the third order (hexapole). The addition of the metallic meta-atom core causes the shifting of certain modes (depending on the core size) leading to mode superposition and a “superscattering” effect. As can be seen, the superposition of higher order modes in (b) leads to more directional scattering;

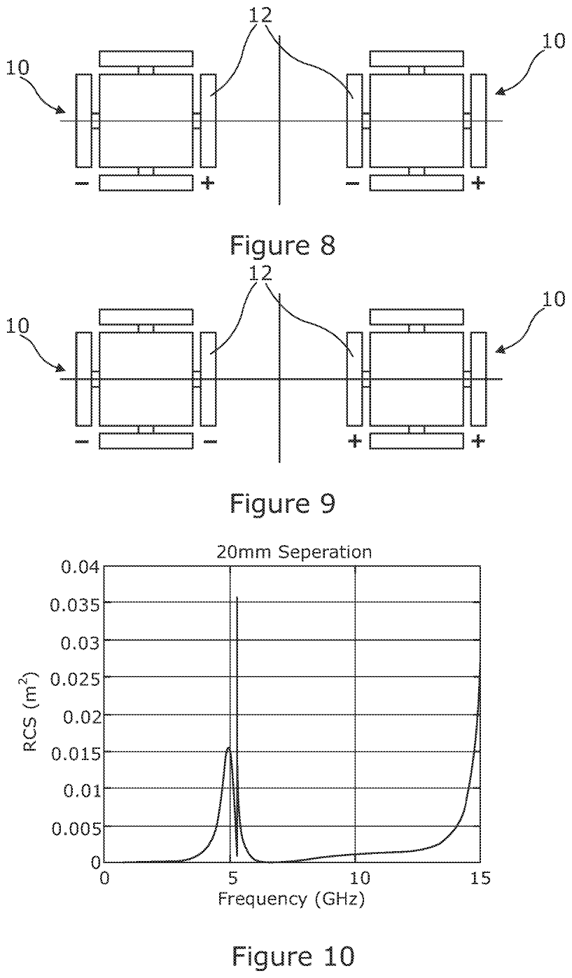

FIG. 8: shows a first system of two 3D metacubes arranged next to each other;

FIG. 9: shows a second system of two 3D metacubes arranged next to each other;

FIG. 10: is a graph of measurements of radar cross section as a function of frequency for the systems of FIGS. 8 and 9, wherein the 3D metacubes are separated by 20 mm;

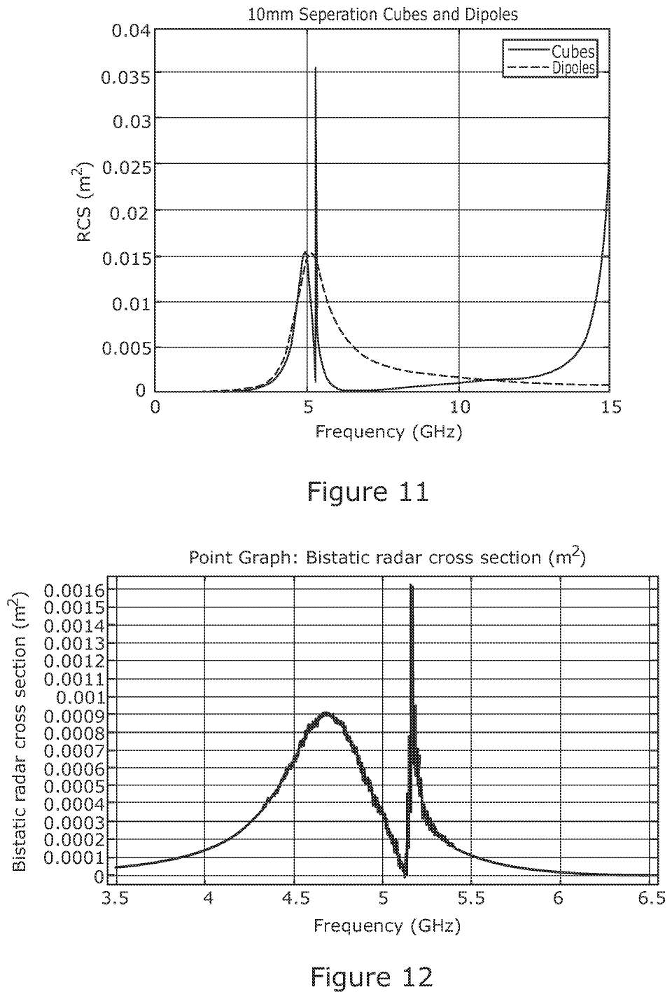

FIG. 11: is a graph of measurements of radar cross section as a function of frequency for the system of FIGS. 8 and 9, wherein the 3D metacubes are separated by 10 mm, and the measurements for a system of two dipoles separated by 10 mm; and

FIG. 12: is a graph of measurements of bistatic radar cross section as a function of frequency for a 3D metacube situated above a metal.

The structure of the 3D metacube 10 of an embodiment of the invention is shown in FIG. 1a. Six metal plate elements or faces 12 are connected via three orthogonal metallic rods 14 forming an internal support structure 16 of the 3D metacube 10, which could also be considered as a metal jack. The 3D metacube structure 10 is conveniently fabricated using a 3D printing technique, and the 3D printed and metal coated structure 10 is shown in FIG. 1b. The thin connecting supports which held the cubes for printing and coating have been removed. The structural resonances of the metacube 10 produce an RCS several times that of a solid copper cube of equivalent cross-section as modelled in FIG. 1c, where the solid line illustrates the RCS for a solid cube and the dotted line shows the RCS for the metacube 10 of the same material and dimensions as the solid cube.

The enhancement in the RCS can be best understood by exploring the case of a single dipole antenna, as shown in FIG. 2a, where the resonance is defined by the dimensions of the rod 20. The addition of perpendicular plates 22 to the ends of the dipole increases the capacitance, resulting in a strong redshift of the resonance to lower frequencies. The increase in surface charge also leads to stronger electric fields as shown in FIG. 2d. It also produces greater current flow across the antenna, which will increase the radiation efficiency, along with the Q-factor of the antenna, as can be seen in FIG. 2e. The Q-factor is raised from Q=1.9 for the simple dipole to Q=3.5 for the dipole loaded with plates 22. The addition of the plates 22 can therefore be said to lead to stronger, narrower, scattering resonances at lower frequencies compared to a simple dipole.

Whilst this effect is significant, due to the limited symmetry of its geometry, the structure shown in FIG. 2b will only demonstrate this behaviour for a given set of incident angles and polarizations. Small RCS objects like drones could be anywhere in three-dimensional space relative to a radar detector or receiver and so this limited angular scope is not sufficient. In accordance with the invention, therefore, the scatterer device is designed to be less limited in this respect, and the metacube 10 shown in FIG. 1a achieves enhanced omnidirectional scattering behaviour. This structure, is effectively formed of three plate-loaded dipoles arranged at right angles to one another, meaning that for any direction and polarisation the scattering at the dipolar resonance should be the same.

FIG. 3a) demonstrates that the superposition of three orthogonal loaded dipoles has only a small effect on the resonance position, and FIG. 3b) highlights the omnidirectional scattering behaviour of the metacube 10, showing that around the dipolar peak the scattering is almost unchanged for all key incident angles and polarisations. For all incident angles, the fundamental mode remains a dipole at the same frequency, although due to interaction between the charges on different plates, the electric nearfield is substantially different to the normal incidence case (FIG. 3c & d). For light incident at an edge and polarised perpendicular to that edge, and light incident at a vertex, secondary mode can be seen to appear as shown in FIG. 3b). This is a quadrupolar mode, as demonstrated in FIG. 3e) & h) and is a consequence of the 3D structure of the metacube 10, as second order modes do not appear in the single loaded dipole structure until about twice the fundamental frequency around 30 GHz. In this way the metacube is seen to behave, optically, like a resonant nanoparticle, where multiple orders of modes closely overlap and can lead to very strong forward and reverse scattering. The narrow nature of these resonances may be of interest for applications that must operate in a limited spectral range, or to use for example in an array to provide a unique “barcode” identifier for an object.

To verify these modelled results, several metacubes 10 were fabricated via stereolithography 3D printing. Samples were then coated in a 5 μm layer of copper, ensuring the copper was thick enough to exceed the skin depth at the frequency of interest (around 0.5 μm at 15 GHz). A typical resulting metacube 10 is illustrated in the photograph of FIG. 1b. Its final dimensions were: overall size 4.35±0.02 mm; plate size 2.78±0.05 mm; plate thickness 0.41±0.02 mm; rod width 0.82±0.03 mm. It is worth noting that due to the small quantity of metal used, these samples are incredibly light, weighing 0.042±0.002 g each, and so even a substantial array of these will only have a negligible impact on the weight of any object they are added to, making them ideal for applications where weight as well as radar visibility are critical, such as quadcopter drones, gliders and cubesats.

The RCS of each these samples was measured experimentally in an anechoic chamber for selected orientations as shown in FIG. 4, demonstrating excellent agreement with the simulations and showing an RCS in the region of around fifteen times greater than the cubes' geometric area.

By appropriate selection of the dimensions and shapes of the plate elements 12 and the rods 20, resonance of the dipoles, and hence of the structure 10 can be tuned, increasing the dimensions of the plate elements 12 reducing the resonant frequency of the structure. By adjustment of the angles between the dipoles to break the symmetry of the structure 10, a polarisation sensitive scatterer may be provided. As mentioned hereinbefore, the rods 20 could be of curved or helical or spiral form, if desired, to increase their effective lengths. The rods 20 need not be of the same length as one another, and this may result in polarization sensitivity. The rods 20 need not be arranged perpendicularly to one another but may be arranged at other angles, if desired.

Whilst specific embodiments of the invention are described herein, it will be appreciated that a wide range of modifications and alterations may be made to the arrangements described herein without departing from the scope of the invention as defined by the appended claims. By way of example, rather than use plate elements 12 of a square form, the plate elements 12 could be of circular or other shapes. Additionally, the plate elements 12 need not be of flat, planar form but rather could be of curved form. By way of example, they may be curved in such a manner as to be of part spherical form, with the result that the device may be of generally spherical form, if desired. Furthermore, by changing the number of dipoles, structures 10 have a greater number, or fewer, faces are possible.

It is also envisaged that the structures 10 may be mounted upon the surface of a larger object such as a drone, satellite, vehicles including cars, boats, aircraft and gliders, on clothing and in a number of other applications. They could be secured in position by suitable adhesives, or could be incorporated into the materials from which at least parts of the objects are fabricated.

If desired, a plurality of such structures could be mounted upon a dielectric material particle to form a larger, more complex structure which may be described as met-particles, with enhanced scattering properties. In such a complex structure, the individual structures 10 could be arranged in a predetermined pattern, or may be randomly arranged, if desired. They may be provided substantially uniformly over the entire surface of the particle, or may be associated with only part thereof, if desired. They may be in contact with the surface of the core particle, or may be spaced therefrom. Meta-particles of this form are illustrated, diagrammatically, in FIG. 5.

FIG. 6 illustrates a structure in which a plurality of such meta-particles are associated with a central core particle, in this case of dielectric form, to form a meta-atom or molecule. The responses of the electric and magnetic dipoles associated with the elements of such a structure may be tuned, through appropriate design thereof, to interact or interfere with one another to result in superposition thereof, spectrally overlapping with one another, at a chosen frequency leading to a particularly large RCS at that frequency as shown in FIG. 6c.

An alternative structure is shown in FIG. 7 in which a metallic meta-particle core is located within or encapsulated within a hollow dielectric shell. Such a core-shell structure may again display, through appropriate design to achieve tuning thereof, a superscattering effect as a result of mode superposition effects, or spectral overlapping, at a chosen frequency.

In the arrangements of FIG. 6 and FIG. 7, not only may a particularly large RCS be achieved, but it may be of enhanced directionality, if desired.

FIGS. 8 and 9 show systems wherein two metacubes 10 are positioned next to each other, close enough that their electromagnetic fields interact. In both systems the metacubes 10 are positioned each with a plate 12 facing a plate 12 of the other. In the system of FIG. 8, for the metacube 10 on the left the facing plate 12 is positively charged and the plate 12 of the other end of the respective dipole is negatively charged, while for the metacube 10 on the right the facing plate 12 is negatively charged and the plate 12 of the other end of the respective dipole is positively charged. In the system of FIG. 9 for the metacube 10 on the left the facing plate 12 is negatively charged and the plate 12 of the other end of the respective dipole is also negatively charged, while for the metacube 10 on the right the facing plate 12 is positively charged and the plate 12 of the other end of the respective dipole is also positively charged.

FIG. 10 shows the RCS measured from the systems of FIGS. 8 and 9 as a function of frequency, when the metacubes 10 are separated by 20 mm. The system has the increased RCS output centred just below 5 GHZ, seen for a single metacube 10. However, there is also a second, narrowband output centred just above 5 GHZ which has a much higher RCS peak. The increased RCS at this frequency is caused by a hybrid mode formed by the electromagnetic interaction between the two metacubes 10.

The bandwidth of this hybrid mode is tuneable by changing the separation between the two metacubes in the system. The narrowband nature of this mode, alongside its higher RCS output, means it has applications for acting as a unique “barcode” identifier and for application wherein the frequency range is more limited.

FIG. 11 shows the RCS measured from the system of FIGS. 8 and 9 as a function of frequency, when the metacubes 10 are separated by 10 mm. It additionally shows the RCS output by a system of two singular dipoles separated by 10 mm. The hybrid mode is present for the system of metacubes, whereas it is not present for a system of singular dipoles. The hybrid mode is therefore a feature of scattering elements interacting with each other electromagnetically.

In an alternative embodiment, instead of two metacubes 10 nearby each other, the system comprises a metacube 10 positioned above a metal. FIG. 12 shows the Bistatic radar cross section output from this system as a function of frequency, and from this the presence of the narrowband, increased output hybrid mode can be observed. As such, the hybrid mode is also a feature of a scattering element interacting electromagnetically with its mirror image in the metal.

It will be appreciated, however, that these merely represent examples of applications in which the invention may be employed, and that the invention is not restricted in this regard.

1. A scattering device comprising a plurality of dipole structures, each comprising a rod and a pair of plates, the plates being located at the respective ends of the rod, the rods of the dipole structures being connected to one another and arranged such that the rods are angled relative to one another.

2. A device according to claim 1, wherein the plates are of generally square shape.

3. A device according to claim 1 or claim 2, wherein three dipole structures are provided.

4. A device according to any of the preceding claims, wherein the dipole structures are arranged such that the plates together define a structure of generally cubic shape, with the interconnected dipole structures together defining a support structure for the plates.

5. A device according to any of the preceding claims, wherein the dipole structures are arranged such that the plates together define a structure of generally spherical shape, with the interconnected dipole structures together defining a support structure for the plates.

6. A device according to any of the preceding claims, wherein the dipole structures are arranged orthogonally to one another.

7. A device according to any of the preceding claims, wherein each dipole structure is of solid metallic form.

8. A device according to any of claims 1 to 7, wherein each dipole structure is of a plastics material, coated with a metallic material coating.

9. A device according to any of the preceding claims, wherein the dipole structures are integrally formed with one another.

10. A device according to any of the preceding claims, and manufactured by 3D printing.

11. A scattering device comprising a plurality of devices as claimed in any of the preceding claims, associated with a central core particle.

12. A scattering device comprising a plurality of scattering devices as claimed in claim 11 located about a central core.

13. A scattering device comprising a hollow shell within which is located a core in the form of a scattering device as claimed in claim 11.

14. A system comprising a first scattering device according to any of claims 1 to 13 and a mirroring element, the mirroring element operable, in use, to form a charge pattern of a scattering device according to the first aspect, wherein the first scattering device and mirroring element are positioned relative to one another to interact electromagnetically in use.

15. A system according to claim 14 wherein the mirroring element is a second scattering element according to any of claims 1 to 13.
